(19) United States
(12) Patent Application Publication
(10) Pub. No.: US 2004/0225737 A1
(43) Pub. Date: Nov. 11, 2004

(54) Method and apparatus for using a received mac address in router communication

(75) Inventors: Jerry W. Eldridge, Alviso, CA (US); Michael B. Shields, San Carlos, CA (US); Tim Shaughnessy, Campbell, CA (US); David M. Fudenberg, Palo Alto, CA (US)

Correspondence Address: WILSON SONSINI GOODRICH & ROSATI, 650 PAGE MILL ROAD, PALO ALTO, CA, 943041050

(73) Assignee: NetGear Inc., Santa Clara, CA

(21) Appl. No.: 10/430,733

(22) Filed: May 5, 2003

(51) Int. Cl. G06F 15/173

(52) U.S. Cl. 709/226; 709/225

(57) ABSTRACT

Methods and apparatus for automatically receiving and using a media access control address in router communications. If an ISP will authorize network communication only with a particular media access control address, a router can automatically use a non-native media access control, i.e. the media access control address registered with the ISP.

### BACKGROUND OF THE INVENTION

Most computer networks include a plurality of computers that are interconnected by communication paths. A network computer may access available resources outside of the local network, such as the Internet or other external network, through a router.

In a packet-switched network, a “router” is a device which receives packets on one or more input interfaces, and which outputs those packets on one of a plurality of output interfaces, so as to move those packets within the network from a source device to a destination device. Each packet includes header information, which indicates the destination device (and other information). The router includes routing information, which associates an output interface with information about the destination device (and possibly with other information). The router can also perform other operations on packets, such as rewriting the packets' headers according to their routing protocol, or to reencapsulate the packets from a first routing protocol to a second routing protocol.

A network administrator or information services (IS) specialist often configures the router to interface with a selected network and a selected Internet service provider (ISP). The process of properly configuring the router to interface with the selected network and ISP is oftentimes a complicated, time-consuming process that requires specialized knowledge on the part of administrators, let alone individual users. There are numerous device settings and network protocol settings that must be properly set, which assume a certain level of proficiency with computer networks. The number of different connection types available from ISPs today is ever increasing; one cause is the proliferation of broadband data services. A router may be connected to a typical telephone connection/plain old telephone service, and/or a high-bandwidth connection such as a cable modem, a Digital Subscriber Line (DSL) modem, or an Integrated Services Digital Network (ISDN) connection. These connection lines can require a distinct configuration for the router.

A router can require proper setting of protocol configurations before it is able to establish a connection to an ISP, and external network resources such as the Internet through the ISP. It may be necessary to configure network addresses, network protocols, routing protocols, timers, and other relevant information. The protocol configuration process typically involves human intervention in setting up the interface with a selected ISP and/or local network. Even when service providers offer some assistance in the installation of a router, physical tasks must still be performed, such as connecting the right cables, positioning the router in an appropriate place within the network, and correct configuration with respect to an ISP. Each ISP may employ a specific connection type and adhere to a particular adopted protocol. Due to the ever increasing number of connection types available today, the configuration process for routers is becoming a more difficult task.

In order to minimize human intervention in configuring a router, previous solutions approached this problem from different perspectives. For example, one technique for simplifying this process involves the installation of configuration software programs or transmission of certain data from an ISP to configure the Internet settings of customer premises equipment. See U.S. Pat. No. 6,314,516 (Method and Apparatus for Configuring Communications Settings in a Computer System), which is incorporated by reference herein in its entirety. Software programs, however, must be provided in certain formats that are compatible with different operating systems that are known or identified ahead of time. Additionally, as described in U.S. Pat. No. 6,463,528 (Method and Apparatus for Simplifying the Configuration of Several Models of Customer Premise Equipment), which is incorporated by reference herein in its entirety, existing techniques may also include method and apparatus for retrieval of configuration parameters from a central system for each device to be configured. These types of systems however may be considered a limited solution from the perspective of the service provider in response to the wide variety of configurations available to customers. Similarly, in U.S. Pat. No. 6,012,088 (Automatic Configuration for Internet Access Device), which is also incorporated by reference herein in its entirety, Internet access devices can also connect automatically to the Internet to retrieve pre-assigned configuration data which is downloaded from a database stored in a configuration server established by an ISP. These proposed solutions, however, do not adequately address the challenges associated with properly configuring a router from the perspective of a user or administrator in accordance with a particular connection types and protocols established by ISPs, or the challenges associated with detecting problems encountered in setting up or using the router.

Also, many end users who encounter difficulties while configuring and/or troubleshooting a router may contact customer support for assistance from the vendor and/or manufacturer of the router. Every such contact, whether via phone, e-mail, letter, or in person, can represent an expense to the vendor and/or manufacturer. In the aggregate, such customer support expenses can reduce or eliminate the profit from the router. Thus, any automated processes which lighten the burden of customer support on the manufacturer and/or vendor can increase the profit from router sales, whether a particular request for customer support is shortened or eliminated. It can also reduce product returns, and/or increase customer satisfaction.

There is an unsatisfied need for simplifying the configuration process of Internet access devices based on particular connection types and the variety of protocols selected by various ISPs, and/or troubleshooting problems that may be encountered during the configuration and/or use of the router.

### BRIEF SUMMARY OF THE INVENTION

Some embodiments of the invention provide methods and apparatuses to assist laypersons or those with limited knowledge of networks in the configuration of routers according to particular connection types used to communicate with Internet service providers (ISPs), and/or troubleshooting router problems.

In some embodiments, a media access control address is automatically received at a router and automatically used in data sent from the router. The media access control address uniquely identifies each node of a network with a hardware address. Often, the media access control address is a 48 bit address which can be written as a 12 digit hexadecimal number.

Some embodiments use code in hardware and/or software to automatically receive a media access control address at a router and automatically use the media access control address in data sent from the router.

Other goals and advantages of the invention will be better appreciated and understood when considered in conjunction with the following description and the accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. Many changes and modifications may be made within the scope of the invention without departing from the spirit thereof, and the invention includes all such modifications.

### BRIEF DESCRIPTION OF THE DRAWINGS

The advantages and features of invention are described herein with reference to the exemplary embodiments and accompanying drawings. It shall be understood that similar or like reference numerals and characters may designate the same or like parts when they occur in more than one view or figure. It should be further noted that the features illustrated in the drawings are not necessarily drawn to scale.

FIG. 1 is a simplified illustration of a computer communicating with an Internet service provider (ISP).

FIG. 2 is a simplified illustration of an ISP refusing authorization to communications with a router.

FIG. 3 is a simplified illustration of an ISP authorizing communications with a router.

FIG. 4 is a simplified flowchart of a router automatically using another computer's media access control address.

FIG. 5 is another simplified flowchart of a router automatically using another computer's media access control address.

### DETAILED DESCRIPTION OF THE INVENTION

The various features and advantages of the invention are explained more fully below with reference to the illustrative embodiments shown in the accompanying drawings.

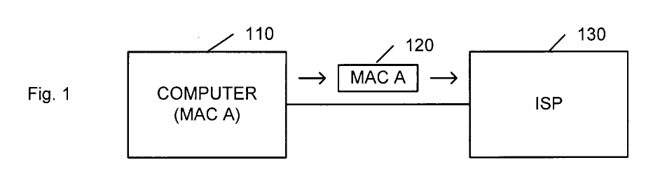

FIG. 1 illustrates a common architecture for computers communicating with external network resources such as the Internet. For simplicity, external access equipment, such as a modem, is not shown. A computer 110 with media access control address “A” communicates with the Internet Service Provider 130. The computer 110 sends data 120 having media access control address “A”, for example in a source address field.

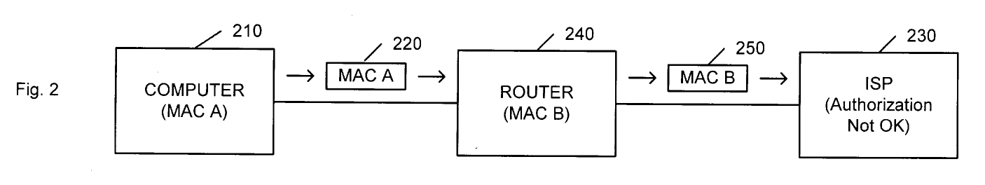

FIG. 2 illustrates another architecture for computers communicating with external network resources such as the Internet. For simplicity, external access equipment, such as a modem, is not shown. A computer 210 with media access control address “A” attempts to communicate with the Internet Service Provider 230. The computer 210 sends data 220 having media access control address “A”, for example in a source address field. Router 240 having media access control address “B” receives the data 220. Router 240 resends the data 220 as data 250 having media access control address “B”. Some Internet service providers are configured to authorize communication with a specific computer i.e. a computer having a particular media access control address registered with the Internet service provider. In the event that media access control address “A” is registered with the ISP 230 but media access control address “B” is not, then ISP 230 may not authorize communications with the router 240.

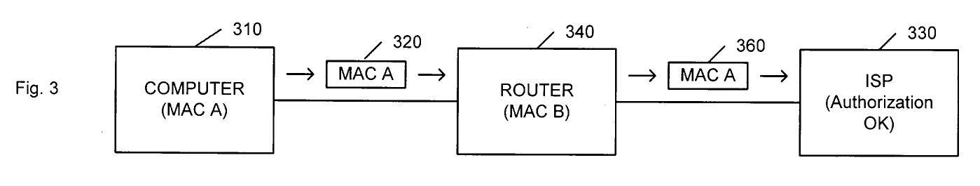

FIG. 3 illustrates another architecture for computers communicating with external network resources such as the Internet. For simplicity, external access equipment, such as a modem, is not shown. A computer 310 with media access control address “A” attempts to communicate with the Internet Service Provider 330. The computer 310 sends data 320 having media access control address “A”. Router 340 having media access control address “B” receives the data 320. Router 340 resends the data 320 as data 350 having media access control address “A”, rather than media access control address “B”. Router 340 has “spoofed” the media access control address “A” of the computer 310. In this case, ISP 330 authorizes communications with the router 340 even if the media access control address “B” of the router 340 is different from the media access control address “A” of the computer 310 which may be registered with the ISP 330, or even if there is another computer (such as a computer not having the MAC address “A”) attached to the router 340 communicating with the ISP 330.

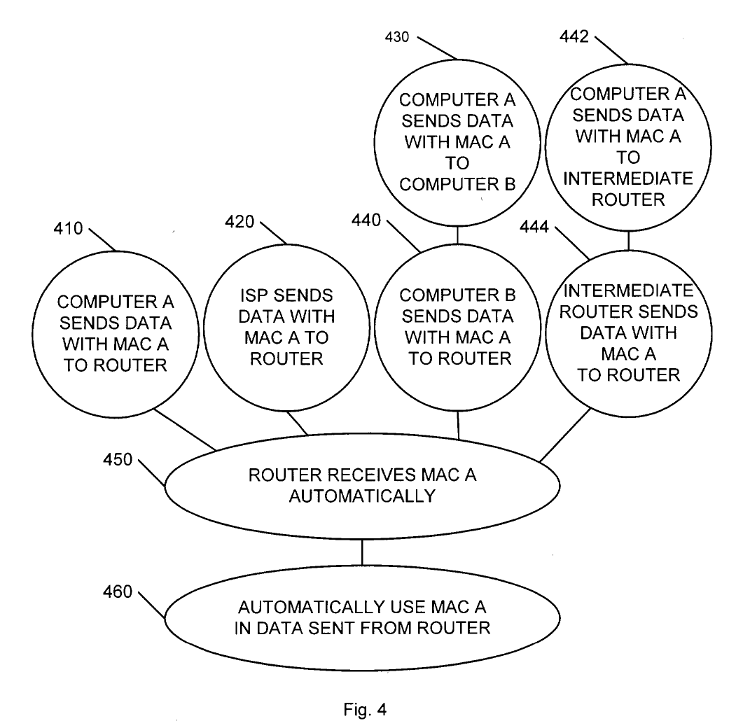

FIG. 4 illustrates a flowchart for computers communicating with external network resources such as the Internet.

In 450, a router receives media access control address “A” automatically.

“Automatically” can indicate that the user does not have to search for and find the media access control address, and does not have to manually enter the digits comprising the media access control address. The media access control address can be in a location that is difficult to reach and/or see, such as the back of a computer or inside the computer. Automatic receipt of the media access control address can remove the need to search for and find the media access control address. The user might otherwise have to physically shift and rotate the computer, attempt to view the back of the computer in a confined area, and/or at least partly disassemble and open up the computer to find the media access control address.

Further, the process of attempting to reach or see the media access control address assumes that the user knows what to look for and will recognize a media access control address when the user sees one. Some users of a router will lack the technical knowledge to even recognize a media access control address, let alone know where to find the media access control address in the computer. Automatic receipt of the media access control address can make unnecessary the knowledge required to recognize a media access control address.

Further still, even if a technically knowledgeable user searches for, finds, and recognizes the media access control address, the user can make an error in the process of manually entering the media access control address into the router. One instance of an error in the manual entry process includes the user misreading or making an error in entering one or more digits of the media access control address, even after finding and recognizing the media access control address. Automatic receipt of the media access control address can remove the user from the process of entering the media access control into router, thereby eliminating the chances that a user will misread or make an error in entering the knowledge required to recognize a media access control address. The user might otherwise be forced to repeat the entire process of finding the media access control address, and make yet another error be misreading or making an error in entering one or more digits of the media access control address.

In 460, in data sent from the router, media access control address “A” is used automatically.

“Automatically” can indicate that the user does not have to authorize the router to use the media access control address of the computer in data sent from the router. Instead, the router can attempt to use the media access control address of the computer without being specifically instructed to do so by the user.

There are multiple possible sources of the media access control address “A”. In 410, the actual computer having media access control address “A” sends data having media access control address “A”, for example in a source address field. In 420, the ISP sends data having media access control address “A”, for example in a destination address field. In 430, computer “A” having media access control address “A” sends data having media access control address “A” to a computer “B” having media access control address “B”. In 440, computer “B” having media access control address “B” sends data having media access control address “A”. Computer “B” may have spoofed the media access control address “A” of computer “A”. Alternatively, computer “B” may have sent media access control address “A” in the payload. In 442, computer “A” having media access control address “A” sends data having media access control address “A” to an intermediate router. In 444, the intermediate router sends data having media access control address “A” to the router.

In some embodiments, the media access control address “A” may be stored, for example in the router or in another computer such as computer “B” having a different media access control address “B”. Once stored, external network resources can be accessed through the router spoofing media access control address “A”, regardless of whether traffic is sent from the computer “A” having media access control address “A” or sent from another computer, such as computer “B” having media access control address “B”, and/or regardless of whether computer “A” is still connected to the router.

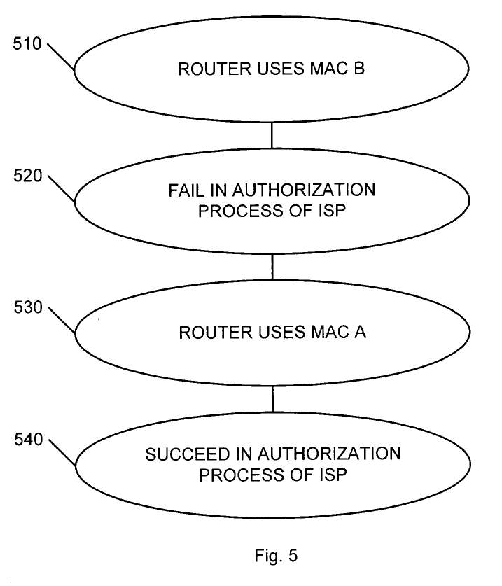

FIG. 5 illustrates a flowchart for computers communicating with external network resources such as the Internet.

In 510, a router uses media access control address “B”, such as by using media access control address “B” in a source address field. In 520, the authorization process of the ISP results in failure. As a result of the failure in 520, in 530, the router uses media access control “A”, such as by spoofing the media access control “A” registered with the ISP in a source address field. In 540, the authorization process of the ISP results in success. Some embodiments skip 510 and 520 and start at 530.

While the invention has been described with reference to the aforementioned specification, the descriptions and illustrations of the preferable embodiments herein are not meant to be construed in a limiting sense. It shall be understood that all aspects of the invention are not limited to the specific depictions, configurations or relative proportions set forth herein which depend upon a variety of conditions and variables. Various modifications in form and detail of the embodiments of the invention, as well as other variations of the invention, will be apparent to a person skilled in the art upon reference to the present disclosure.

What is claimed is:

1. A method of router configuration, comprising:
automatically receiving, at a router, a media access control address of a computer; and
automatically using the media access control address of the computer in data sent from the router.

2. A method of claim 1, further comprising:
at least partly in response to an internet service provider receiving the data sent from the router using the media access control address of the computer, succeeding in an authorization process of an internet service provider, wherein the authorization process of the internet service provider is configured to authorize data communication between the internet service provider and the media access control address of a computer.

3. The method of claim 2, further comprising:
prior to succeeding in the authorization process of the internet service provider, failing in the authorization process of the internet service provider, the failing at least partly in response to data sent from the router using a second media access control address.

4. The method of claim 3, wherein the second media access control address is a native media access control address of the router.

5. The method of claim 3, wherein the second media access control address is a media access control address of a second computer.

6. The method of claim 5, wherein the media access control address of the computer is chosen from a plurality of media access control addresses of a plurality of computers coupled to the router.

7. The method of claim 2, wherein the automatically used media access control address of the computer is received from the computer.

8. The method of claim 2, wherein the automatically used media access control address of the computer is received from the internet service provider.

9. The method of claim 2, wherein the automatically used media access control address of the computer is received from a second computer.

10. The method of claim 2, wherein the automatically used media access control address of the computer is received from a second router.

11. The method of claim 2, further comprising:
storing the media access control address of the computer in the router.

12. The method of claim 11, further comprising:
storing the media access control address of the computer in the router.

13. The method of claim 12, further comprising:
automatically using the stored media access control address of the computer in data sent from the router.

14. Computer code for router configuration, comprising:
code that performs automatically receiving, at a router, a media access control address of a computer; and
code that performs automatically using the media access control address of the computer in data sent from the router.

15. The code of claim 14, further comprising:
code that performs, at least partly in response to an internet service provider receiving the data sent from the router using the media access control address of the computer, succeeding in an authorization process of an internet service provider, wherein the authorization process of the internet service provider is configured to authorize data communication between the internet service provider and the media access control address of a computer.

16. The code of claim 15, further comprising:
code that performs, prior to succeeding in the authorization process of the internet service provider, failing in the authorization process of the internet service provider, the failing at least partly in response to data sent from the router using a second media access control address.

17. The code of claim 16, wherein the second media access control address is a native media access control address of the router.

18. The code of claim 16, wherein the second media access control address is a media access control address of a second computer.

19. The code of claim 18, wherein the media access control address of the computer is chosen from a plurality of media access control addresses of a plurality of computers coupled to the router.

20. The code of claim 15, wherein the automatically used media access control address of the computer is received from the computer.

21. The code of claim 15, wherein the automatically used media access control address of the computer is received from the internet service provider.

22. The code of claim 15, wherein the automatically used media access control address of the computer is received from a second computer.

23. The code of claim 15, wherein the automatically used media access control address of the computer is received from a second router.

24. The code of claim 15, further comprising:
code that performs storing the media access control address of the computer in the router.

25. The code of claim 24, further comprising:
code that performs storing the media access control address of the computer in the router.

26. The code of claim 25, further comprising:
code that performs automatically using the stored media access control address of the computer in data sent from the router.

27. The code of claim 14, wherein at least part of the computer code is at least partly hardware.

28. The code of claim 14, wherein at least part of the computer code is at least partly software.

29. The code of claim 14, wherein at least part of the computer code is native to the router.

30. The code of claim 14, wherein at least part of the computer code is received at the router.

31. The code of claim 14, wherein at least part of the computer code is executed at the router.

32. The code of claim 14, wherein at least part of the computer is executed outside the router.

33. Apparatus for router configuration, comprising:
means for automatically receiving, at a router, a media access control address of a computer; and
means for automatically using the media access control address of the computer in data sent from the router.
